(19) United States
(12) Patent Application Publication
(10) Pub. No.: US 2026/0135319 A1
(43) Pub. Date: May 14, 2026

(54) CONNECTOR TERMINAL, CONNECTOR AND CONNECTOR ASSEMBLY

(71) Applicant: Tyco Electronics (Shanghai) Co., Ltd., Shanghai (CN)

(72) Inventors: Wenxia (Cecily) Zhou, Shanghai (CN); YuQiang (Thomas) Zhao, Shanghai (CN); William (Wei) Yao, Kunshan (CN)

(73) Assignee: Tyco Electronics (Shanghai) Co., Ltd., Shanghai (CN)

(21) Appl. No.: 19/385,678

(22) Filed: Nov. 11, 2025

(30) Foreign Application Priority Data
Nov. 11, 2024 (CN) 202411604843.2

(51) Int. Cl. H01R 13/436; H01R 4/18; H01R 13/11; H01R 13/50; H01R 43/16

(52) U.S. Cl. CPC H01R 13/4361; H01R 4/185; H01R 13/113; H01R 13/50; H01R 43/16

(57) ABSTRACT

A connector terminal includes a mating part. The mating part has a front ring part, a rear cylinder part opposite the front ring part in a longitudinal direction of the mating part, and an elastic part between the front ring part and the rear cylinder part. The elastic part includes an upper spring arm, a lower spring arm opposite the upper spring arm in a height direction of the mating part, a left spring arm, and a right spring arm opposite the left spring arm in a transverse direction of the mating part. The upper spring arm, the lower spring arm, the left spring arm, and the right spring arm simultaneously electrically contact a mating terminal inserted into the mating part.

### CROSS-REFERENCE TO RELATED APPLICATION

This application claims the benefit of the filing date under 35 U.S.C. § 119(a)-(d) of Chinese Patent Application No. CN202411604843.2 filed on Nov. 11, 2024, the whole disclosure of which is incorporated herein by reference.

### FIELD OF THE INVENTION

The present invention relates to a connector terminal and, more particularly, to a connector terminal, a connector comprising the connector terminal, and a connector assembly comprising the connector.

### BACKGROUND OF THE INVENTION

The terminal of a connector usually has two contact bumps, which are formed on the left and right opposite side walls of the terminal respectively, for simultaneous electrical contact with left and right sides of an inserted mating terminal. However, the electrical contact between the existing two contact bumps and the mating terminal is unreliable, which can easily lead to poor electrical contact. In order to ensure reliable electrical contact, it is necessary to increase the interference between the contact bump and the mating terminal, but an increase in interference can lead to a sharp increase in insertion and extraction force. In addition, in order to lock the terminal in the housing of the connector, it is necessary to punch a locking spring on the terminal, which will result in the formation of a larger slot on the terminal, which will reduce the strength of the terminal. Moreover, the stamped locking spring has poor strength and cannot reliably lock the terminal in the housing. Under high tensile force, it is easy for it to be damaged and fail.

### SUMMARY OF THE INVENTION

A connector terminal includes a mating part. The mating part has a front ring part, a rear cylinder part opposite the front ring part in a longitudinal direction of the mating part, and an elastic part between the front ring part and the rear cylinder part. The elastic part includes an upper spring arm, a lower spring arm opposite the upper spring arm in a height direction of the mating part, a left spring arm, and a right spring arm opposite the left spring arm in a transverse direction of the mating part. The upper spring arm, the lower spring arm, the left spring arm, and the right spring arm simultaneously electrically contact a mating terminal inserted into the mating part.

### BRIEF DESCRIPTION OF DRAWINGS

The invention will now be described by way of example with reference to the accompanying figures, of which:

FIG. 1 is a top perspective view of a connector terminal according to an exemplary embodiment;

FIG. 2 is a bottom perspective view of the connector terminal of FIG. 1;

FIG. 3 is a top longitudinal sectional view of the connector terminal of FIG. 1;

FIG. 4 is a bottom longitudinal sectional view of the connector terminal of FIG. 1;

FIG. 5 is a perspective view of a connector according to an exemplary embodiment;

FIG. 6 is an exploded view of the connector of FIG. 5; and

FIG. 7 is a longitudinal sectional view of the connector of FIG. 5.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

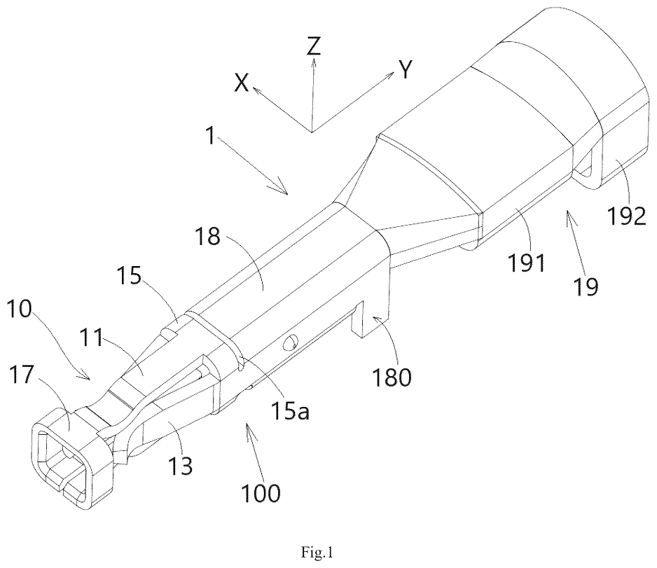

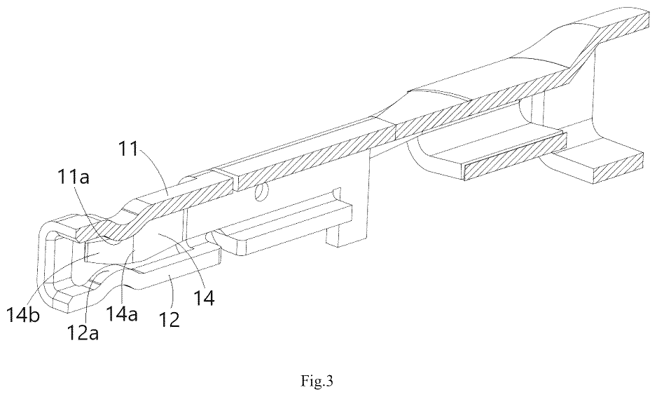

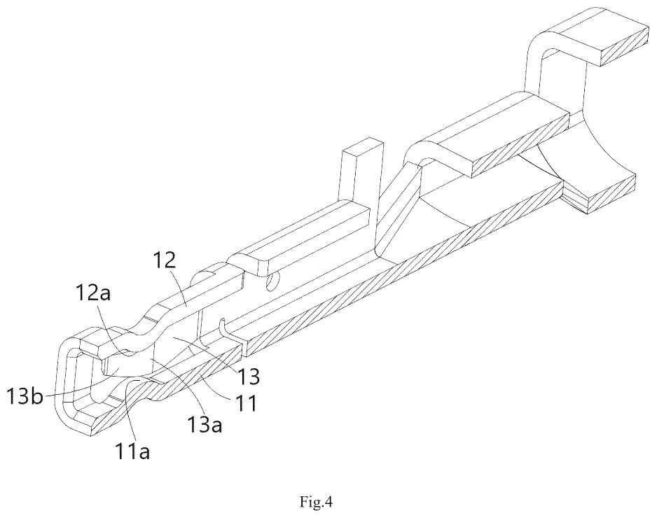

An exemplary embodiment of a connector terminal 1 will now be described with reference to FIGS. 1-4. As shown in FIG. 1, the connector terminal 1 includes a mating part 100 for mating with a mating terminal. The mating part 100 has a front ring part 17 and a rear cylinder part 18 that are opposite in its longitudinal direction Y, as well as an elastic part 10 located between the front ring part 17 and the rear cylinder part 18. As shown in FIGS. 3-4, the elastic part 10 includes an upper spring arm 11 and a lower spring arm 12 that are opposite in the height direction Z of the mating part 100, as well as a left spring arm 13 and a right spring arm 14 that are opposite in the transverse direction X of the mating part 100. The upper spring arm 11, the lower spring arm 12, the left spring arm 13, and the right spring arm 14 of the elastic part 10 are suitable for simultaneous electrical contact with the mating terminal inserted into the mating part 100.

The cross-section of the front ring part 17 and the rear cylinder part 18 is rectangular, and the front ring part 17 and the rear cylinder part 18 respectively have top and bottom walls that are opposite in the height direction Z, and left and right walls that are opposite in the transverse direction X.

As shown in FIGS. 3-4, the left and right spring arms 13 and 14 are elastic cantilevers with fixed rear ends and free front ends. The rear ends of the left and right spring arms 13 and 14 are connected to the left and right walls of the rear cylinder part 18, respectively. The front ends of the left and right spring arms 13 and 14 are adjacent to the left and right walls of the front ring part 17, respectively.

A left contact point 13a, as shown in FIG. 4, and a right contact point 14a, as shown in FIG. 3, are formed on the front ends of the left and right spring arms 13 and 14, respectively. The left contact point 13a and right contact point 14a are used to make electrical contact with the left and right sides of the inserted mating terminal, respectively.

A left and inclined surface 13b and a right inclined surface 14b, as shown in FIGS. 3-4, are respectively formed on the inner side of the front ends of the left and right spring arms 13 and 14, which are inclined with respect to the longitudinal direction Y. The left inclined surface 13b and the right inclined surface 14b define a flared trumpet entrance for guiding the mating terminal to be inserted into the elastic part 10.

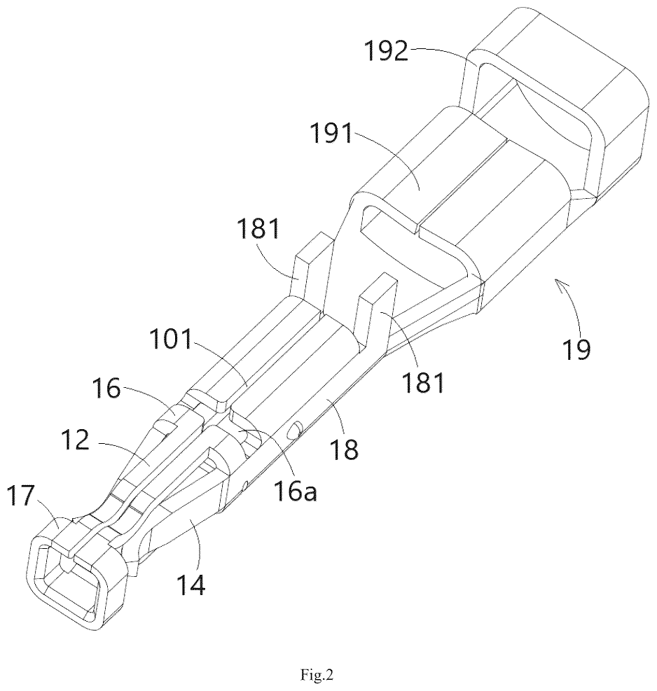

The elastic part 10 further includes an upper U-shaped arm 15, as shown in FIG. 1, and a lower U-shaped arm 16, as shown in FIG. 2. The two ends of the upper U-shaped arm 15 are respectively connected to the upper sides of the rear ends of the left and right spring arms 13 and 14, and the two ends of the lower U-shaped arm 16 are respectively connected to the lower sides of the rear ends of the left and right spring arms 13 and 14. The rear ends of the upper spring arm 11 and the lower spring arm 12 are respectively connected to the upper U-shaped arm 15 and the lower U-shaped arm 16, and the front ends of the upper spring arm 11 and the lower spring arm 12 are respectively connected to the top and bottom walls of the front ring part 17.

As shown in FIGS. 1-2, an upper contact point 11a and a lower contact point 12a are formed on the front ends of the upper spring arm 11 and the lower spring arm 12, respectively. The upper contact point 11a and the lower contact point 12a are used to make electrical contact with the upper and lower sides of the inserted mating terminal, respectively.

As shown in FIG. 1, there is an upper U-shaped groove 15a between the upper U-shaped arm 15 and the rear cylinder part 18, so that the upper U-shaped arm 15 and the rear cylinder part 18 are separated in the longitudinal direction Y by the upper U-shaped groove 15a. As shown in FIG. 2, there is a lower U-shaped groove 16a between the lower U-shaped arm 16 and the rear cylinder part 18, so that the lower U-shaped arm 16 and the rear cylinder part 18 are separated in the longitudinal direction Y by the lower U-shaped groove 16a.

As shown in FIG. 1, a protruding locking portion 180 is formed at the rear end of the rear cylinder part 18, which is used to press against the locking piece 3 inserted into the housing 2 of the connector to lock the connector terminal 1 in the housing 2 of the connector. The locking portion 180 includes a pair of protruding tongues 181, as shown in FIG. 2, which are respectively connected to the lower sides of the left and right walls of the rear cylinder part 18 and protrude downward relative to the bottom wall of the rear cylinder part 18.

As shown in FIGS. 1-2, the connector terminal 1 further includes a crimping part 19. The crimping part 19 is connected to the rear end of the rear cylinder part 18 for crimping onto a cable of the connector to electrically connect with the cable. As shown in FIGS. 1-2, the crimping part 19 includes a first crimping part 191 and a second crimping part 192. The first crimping part 191 is used to be crimped onto the exposed conductor end of the cable. The second crimping part 192 is used to be crimped onto the outer layer of the cable. The first crimping part 191 is located between the rear end of the rear cylinder part 18 and the second crimping part 192.

As shown in FIG. 2, a slit 101 extending along the longitudinal direction Y is formed on the bottom of the mating part 100, which divides the bottom walls of the rear cylinder part 18 and the front ring part 17, as well as the lower spring arm 12, in half. The slit 101 is defined between two side edges of a sheet metal forming the connector terminal 1. As shown in FIG. 1, the connector terminal 1 is a one-piece stamped part.

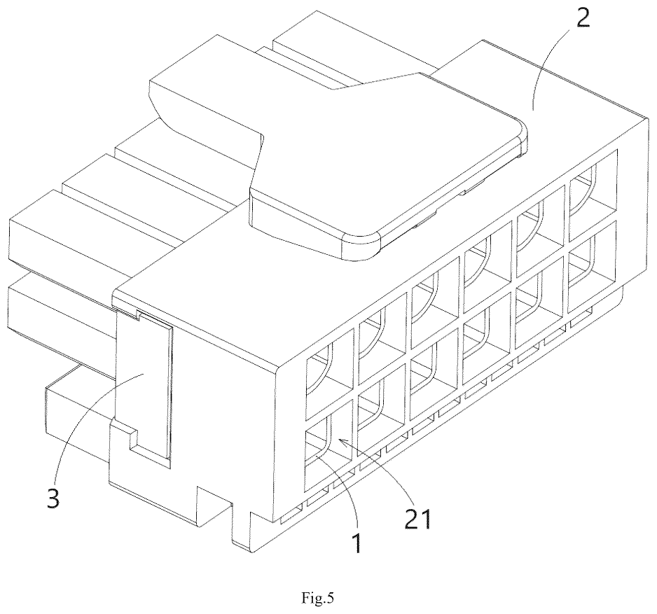

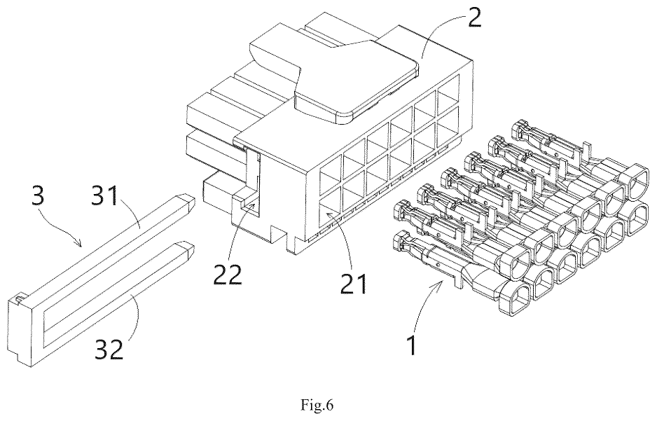

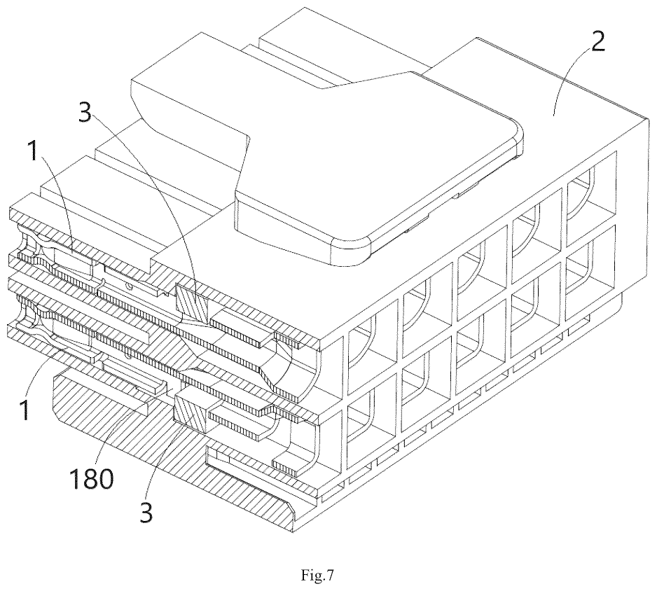

An exemplary embodiment of a connector will now be described with reference to FIGS. 1-7. The connector includes a housing 2, as shown in FIGS. 5-7, and the connector terminal 1, as shown in FIGS. 1 and 5-7. As shown in FIGS. 5-6, a terminal hole 21 extending along the longitudinal direction Y is formed in the housing 2. The connector terminal 1 is inserted into the terminal hole 21.

As shown in FIGS. 5-7, the connector further comprises a locking piece 3. The locking piece 3 is inserted into the housing 2 and rests against the locking portion 180 of the connector terminal 1 to lock the connector terminal 1 in the terminal hole 21. This can prevent the connector terminal 1 from being pulled out of the terminal hole 21.

As shown in FIG. 6, two rows of terminal holes 21 are formed in the housing 2, and the connector includes two rows of connector terminals 1 that are respectively inserted into the two rows of terminal holes 21. A transverse slot 22, as shown in FIG. 6, is formed on the housing 2, which is connected to the upper and lower rows of terminal holes 21. The locking piece 3 is inserted into the transverse slot 22. As shown in FIG. 6, the locking piece 3 has an upper locking arm 31 and a lower locking arm 32. The upper locking arm 31 rests against the locking portions 180 of the upper row of connector terminals 1, and the lower locking arm 32 rests against the locking portions 180 of the lower row of connector terminals 1.

The connector further includes a cable that is electrically connected to the rear end of connector terminal 1 and leads out from the rear port of terminal hole 21.

An exemplary embodiment of a connector assembly will now be described with reference to FIGS. 1-7. The connector assembly includes the aforementioned connector according to FIG. 1-7 and a mating connector. The mating connector is mated with the connector. The mating connector includes a mating housing and mating terminals. The mating housing is mated with the housing 2. The mating terminal is set in the mating housing and mated with the connector terminal 1.

In the aforementioned exemplary embodiments according to the present invention, the connector terminal 1 can simultaneously make electrical contact with the four sides of the inserted mating terminal, improving the reliability and stability of electrical contact.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector terminal, comprising:
a mating part having a front ring part, a rear cylinder part opposite the front ring part in a longitudinal direction of the mating part, and an elastic part between the front ring part and the rear cylinder part;
the elastic part includes an upper spring arm, a lower spring arm opposite the upper spring arm in a height direction of the mating part, a left spring arm, and a right spring arm opposite the left spring arm in a transverse direction of the mating part;
the upper spring arm, the lower spring arm, the left spring arm, and the right spring arm simultaneously electrically contact a mating terminal inserted into the mating part.

2. The connector terminal of claim 1, wherein a cross-section of the front ring part and the rear cylinder part is rectangular, the front ring part and the rear cylinder part each have a top wall and a bottom wall that are opposite in the height direction and a left wall and a right wall that are opposite in the transverse direction.

3. The connector terminal of claim 2, wherein the left spring arm and the right spring arm are elastic cantilevers each having a fixed rear end and a free front end, the rear ends of the left spring arm and the right spring arm are respectively connected to the left wall and the right wall of the rear cylinder part, the front ends of the left spring arm and the right spring arm are respectively adjacent to the left wall and the right wall of the front ring part.

4. The connector terminal of claim 3, wherein a left contact point and a right contact point protruding inward are respectively formed on the front end of the left spring arm and the front end of the right spring arm, the left contact point and the right contact point respectively electrically contact a left side and a right side of the inserted mating terminal.

5. The connector terminal of claim 3, wherein a left inclined surface and a right inclined surface that are inclined with respect to the longitudinal direction are respectively formed on an inner side of the front end of the left spring arm and an inner side of the front end of the right spring arm, the left inclined surface and the right inclined surface define a flared trumpet entrance for guiding the mating terminal to be inserted into the elastic part.

6. The connector terminal of claim 3, wherein the elastic part has an upper U-shaped arm and a lower U-shaped arm, two ends of the upper U-shaped arm are respectively connected to an upper side of the rear end of the left spring arm and an upper side of the rear end of the right spring arm, two ends of the lower U-shaped arm are respectively connected to a lower side of the rear end of the left spring arm and a lower side of the rear end of the right spring arm.

7. The connector terminal of claim 6, wherein the rear end of the upper spring arm and the rear end of the lower spring arm are respectively connected to the upper U-shaped arm and the lower U-shaped arm, the front end of the upper spring arm and the front end of the lower spring arm are respectively connected to the top wall and the bottom wall of the front ring part.

8. The connector terminal of claim 7, wherein an upper contact and a lower contact protruding inward are respectively formed on the front end of the upper spring arm and the front end of the lower spring arm, the upper contact and the lower contact respectively electrically contact the upper side and the lower side of the inserted mating terminal.

9. The connector terminal of claim 7, wherein an upper U-shaped groove is between the upper U-shaped arm and the rear cylinder part such that the upper U-shaped arm and the rear cylinder part are separated in the longitudinal direction, and a lower U-shaped groove is between the lower U-shaped arm and the rear cylinder part such that the lower U-shaped arm and the rear cylinder part are separated in the longitudinal direction.

10. The connector terminal of claim 1, wherein a locking portion is formed at the rear end of the rear cylinder part, the locking portion rests against a locking piece inserted into a housing of a connector to lock the connector terminal in the housing of the connector.

11. The connector terminal of claim 10, wherein the locking portion has a pair of protruding tongues, the pair of protruding tongues respectively connect to a lower side of a left wall and a lower side of a right wall of the rear cylinder part and protrude downward relative to a bottom wall of the rear cylinder part.

12. The connector terminal of claim 1, further comprising a crimping part connected to the rear end of the rear cylinder part, the crimping part is crimped onto a cable of a connector for electrical connection with the cable.

13. The connector terminal of claim 12, wherein the crimping part has a first crimping part crimping onto an exposed conductor end of the cable and a second crimping part crimping onto an outer layer of the cable, the first crimping part is between the rear end of the rear cylinder part and the second crimping part.

14. The connector terminal of claim 1, wherein a slit extending along the longitudinal direction is formed on a bottom of the mating part, the slit divides the lower spring arm in half, and the slit divides a bottom wall of the rear cylinder part and a bottom wall of the front ring part in half.

15. The connector terminal of claim 1, wherein the connector terminal is an integral stamped piece.

16. A connector, comprising:
a housing formed with a terminal hole extending along a longitudinal direction of the housing; and
a connector terminal including a mating part, the mating part has a front ring part, a rear cylinder part opposite the front ring part in a longitudinal direction of the mating part, and an elastic part between the front ring part and the rear cylinder part, the elastic part includes an upper spring arm, a lower spring arm opposite the upper spring arm in a height direction of the mating part, a left spring arm, and a right spring arm opposite the left spring arm in a transverse direction of the mating part, the upper spring arm, the lower spring arm, the left spring arm, and the right spring arm simultaneously electrically contact a mating terminal inserted into the mating part, the connector terminal is inserted into the terminal hole.

17. The connector of claim 16, further comprising a locking piece inserted into the housing and pressed against a locking portion of the connector terminal to lock the connector terminal in the terminal hole.

18. The connector of claim 17, wherein an upper row of terminal holes and a lower row of terminal holes are formed in the housing, and the connector has an upper row of connector terminals and a lower row of connector terminals respectively inserted into the upper row of terminal holes and the lower row of terminal holes, a transverse slot connected to the upper and lower rows of terminal holes is formed on the housing, the locking piece is inserted into the transverse slot and has an upper locking arm and a lower locking arm, the upper locking arm rests against locking portions of the upper row of connector terminals, and the lower locking arm rests against locking portions of the lower row of connector terminals.

19. The connector of claim 16, further comprising a cable electrically connected to the rear end of the connector terminal and lead out from the rear port of the terminal hole.

20. A connector assembly, comprising:
a connector including a housing and a connector terminal, the housing is formed with a terminal hole extending along a longitudinal direction of the housing, and the connector terminal includes a mating part, the mating part has a front ring part, a rear cylinder part opposite the front ring part in a longitudinal direction of the mating part, and an elastic part between the front ring part and the rear cylinder part, the elastic part includes an upper spring arm, a lower spring arm opposite the upper spring arm in a height direction of the mating part, a left spring arm, and a right spring arm opposite the left spring arm in a transverse direction of the mating part, the connector terminal is inserted into the terminal hole; and
a mating connector mated with the connector, the mating connector includes a mating housing and a mating terminal, the mating housing is mated with the housing of the connector, the mating terminal is set in the mating housing and mated with the connector terminal, the upper spring arm, the lower spring arm, the left spring arm, and the right spring arm simultaneously electrically contact the mating terminal inserted into the mating part.
